(19) United States
(12) Patent Application Publication
(10) Pub. No.: US 2008/0181649 A1
(43) Pub. Date: Jul. 31, 2008

(54) Method for analyzing print/copy job

(75) Inventors: Bobo Wang, Hsinchu (TW); Shih-Liang Chang, Hsinchu (TW)

Correspondence Address: Joe McKinney Muncy, PO Box 1364, Fairfax, VA, 22038-1364, US

(73) Assignee: AETAS TECHNOLOGY INCORPORATED

(21) Appl. No.: 11/902,316

(22) Filed: Sep. 20, 2007

(30) Foreign Application Priority Data
Jan. 26, 2007 (TW) 96103085

(51) Int. Cl. G03G 21/02

(52) U.S. Cl. 399/79

(57) ABSTRACT

A method for analyzing a print/copy job is disclosed. In this method, an actual page count of a print/copy job is recorded, and a total toner coverage for the print/copy job is compiled. Then, a total toner coverage page count is obtained via a computation using a predetermined threshold value and the total toner coverage, wherein the predetermined threshold value is an amount of a toner coverage for a print/copy page under normal fare, and when the actual page count of the print/copy job is less than the total toner coverage page count, a toner coverage adjustment page count is equal to the total toner coverage page count. Thereafter, a report is produced in accordance with the print/copy job.

### RELATED APPLICATIONS

This application claims priority to Taiwan Application Serial Number 96103085, filed Jan. 26, 2007, which is herein incorporated by reference.

### BACKGROUND

1. Field of Invention

The present invention relates to a method for analyzing a resource-consuming job executed at a copier, a printer, a multifunction machine or another apparatus. More particularly, the present invention relates to a method for analyzing a print/copy job which uses the resource of a copier a printer, a multifunction machine or another apparatus.

2. Description of Related Art

When a copying/printing apparatus is used to perform a print/copy job on an image, a charger applies a charging voltage to a photoreceptor so that the photoreceptor has a surface potential. Then, the image to be printed is converted into an optical signal by the light-emitting diodes (LED) or laser and irradiated on the photoreceptor with the surface potential to start the exposing step, so that the irradiated region and the un-irradiated region have different potentials. Such a potential difference is used to represent the potential image, also called the latent image.

Then, the electrostatic force makes the toner of a developing unit adhere to the latent image area so as to form a toner image, which is referred to as a developing step.

After the developing step is completed, a transferring step is performed for transferring the toner image adsorbed on the photoconductor to a print/copy substrate (such as a sheet of paper).

However, since the image on each print/copy unit (for example, each sheet) is different, it requires a different toner usage amount. In the prior art, there are a lot of methods used for monitoring the resource usage required by print/copy jobs, referring to, for example, U.S. Pat. No. 7,106,462 by Donald J. Samuels; U.S. Pat. No. 5,937,225 by Donald J. Samuels; U.S. Pat. No. 5,349,377 by W. Keith Gilliland; and U.S. Pat. No. 5,797,061 by Gary Scott Overall, wherein the resource requirements of each print/copy job is provided by analyzing a ratio of laser on and laser off times for the print/copy job, and via a complicated algorithm; or a balance page count that can be printed is predicted by using a level change signal regarding toner high/low provided by a toner measuring device.

The applications of the conventional skills require complicated algorithms, thus increasing the burden of computer or copying/printing apparatus, so that the next print/copy job or another related operation is delayed. Besides, in the conventional skills, the statistical analysis of toner usage is used for the purpose of monitoring the toner remaining amount to predict the balance page count which can be printed. However, the conventional skills cannot analyze each sheet's printing cost. For example, conventionally, when a user is using a pay copying/printing apparatus, its fare calculation is based on the user's actual print/copy page count. However, since the toner amount used by each printed image unit is different, the fare calculation based on the actual print/copy page count cannot reflect the actual printing cost. Hence, a method for rapidly analyzing a print/copy job is desired, wherein a related resource report can be generated in accordance with the print/copy job, and the cost of each print unit can be estimated as the basis for management.

### SUMMARY

One aspect of the present invention is to provide a method for analyzing a print/copy job, thereby providing a reasonable cost estimation.

Another aspect of the present invention is to provide a method for analyzing a print/copy job, thereby generating a report in accordance with a resource-consuming job.

In accordance with the aforementioned aspects, a method for analyzing a print/copy job is provided, and comprises recording an actual page count of the print/copy job; compiling a total toner coverage for the print/copy job; obtaining a total toner coverage page count via a computation using a predetermined threshold value and the total toner coverage, wherein the predetermined threshold value is an amount of a toner coverage for a print/copy page under normal fare, and when the actual page count of the print/copy job is less than the total toner coverage page count, a toner coverage adjustment (TCA) page count is equal to the total toner coverage page count.

When the resource-consuming job is a color print/copy job, the total toner coverage can include a yellow toner coverage, a magenta toner coverage, a cyan toner coverage and a black toner coverage. When the resource-consuming job is a monochrome black print/copy job, the total toner coverage can be a black toner coverage.

The method for analyzing a print/copy job according to the present invention is directed to compiling a total toner coverage for a resource-consuming job; using a predetermined threshold to obtain a reasonable cost estimation; and generating a related report for the print/copy job.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic flow chart showing a method for analyzing a print/copy job according to an embodiment of the present invention;

FIG. 2 is a schematic diagram illustrating an activity log generated by the method for analyzing the print/copy job shown in FIG. 1;

FIG. 3 is a schematic diagram illustrating a personal activity log generated by the method for analyzing the print/copy job shown in FIG. 1;

FIG. 4 is a schematic diagram illustrating a summary report generated by the method for analyzing the print/copy job shown in FIG. 1;

FIG. 5 is a schematic diagram illustrating a real-time monitoring report generated by the method for analyzing the print/copy job shown in FIG. 1;

FIG. 6 is a schematic diagram illustrating a summary report of a branch generated by the method for analyzing the print/copy job shown in FIG. 1; and

FIG. 7 is a schematic diagram illustrating a summary report of a corporation generated by the method for analyzing the print/copy job shown in FIG. 1.

### DESCRIPTION OF THE PREFERRED EMBODIMENTS

The method of the present invention for analyzing a print/copy job is to use a predetermined threshold and a total toner coverage of a resource-consuming job to obtain a toner coverage page count, and to generate a related report of resource usage in accordance with the resource-consuming job. Hence, the present invention uses a relatively simple algorithm to provide a reasonable cost estimation and the analysis of resource utilization. Hereinafter, reference will now be made in detail to the preferred embodiments of the present invention, examples of which are illustrated in the accompanying drawings.

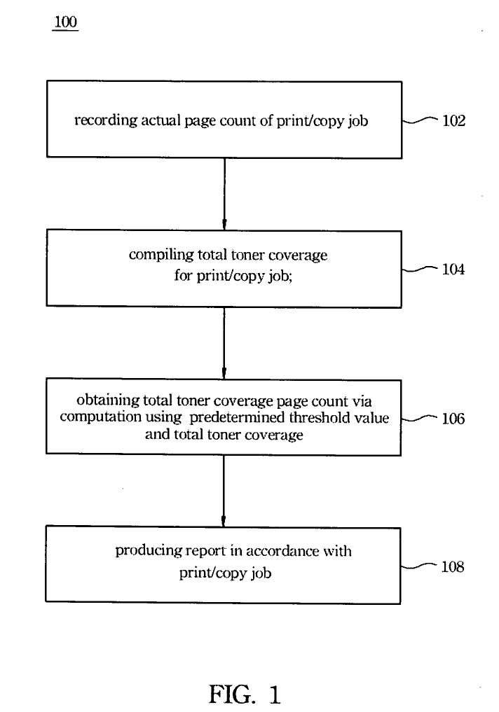

A copying/printing apparatus performs a print/copy job via several steps including a charging step, an exposure step, a developing step and a transferring step. Referring to FIG. 1, FIG. 1 is a schematic flow chart showing a method for analyzing a print/copy job according to an embodiment of the present invention.

A method 100 for analyzing a print/copy job comprises a step 102 for recording an actual page count of a print/copy job; and a step 104 for compiling a total toner coverage (%) for the print/copy job. For example, the total toner coverage required for this resource-consuming job (print/copy job) is estimated by using the number of laser or LED on/off times.

Step 106 is to obtain a total toner coverage page count via a computation using a predetermined threshold value and the total toner coverage. The predetermined threshold value is defined as an amount of a toner coverage for a print/copy page under normal fare, i.e. a toner coverage (%). According to ISO/IEC 19752, the toner coverage (predetermined threshold value) for a monochrome black copy job is about 5%, and that for a color print job or a color copy job is about 20%. A toner coverage adjustment (TCA) page count can be a page count for charge as a reasonable cost calculation of print/copy job, wherein the TCA page count is equal to the total toner coverage divided by the predetermined threshold, and is obtained by rounding up.

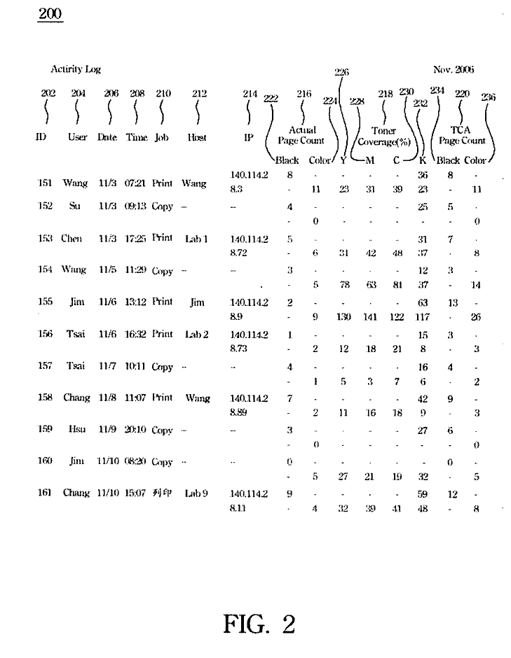

Step 108 is to produce a report in accordance with the print/copy job. FIG. 2 to FIG. 7 are schematic diagrams respectively showing several types of reports generated in accordance with the embodiment of the present invention. FIG. 2 is a schematic diagram illustrating an activity log generated by the method for analyzing the print/copy job according to the embodiment of the present invention. An activity log 200 comprises a TCA (toner coverage adjustment) page count field 220 recording the TCA page count generated by compiling the print/copy job. The TCA page count field 220 includes a black sub-field 234 recording a black TCA page count, and a color sub-field 236 recording a color TCA page count.

The black TCA page count is equal to the value listed in a black toner coverage sub-field 232 divided by 5 with rounding up, and the color TCA page count is equal to the sum of the values listed in the respective yellow, magenta, cyan and black sub-fields 226, 228, 230 and 232 divided by 20 with rounding up. Those yellow, magenta, cyan and black sub-fields 226, 228, 230 and 232 are listed under a toner coverage field 218.

When a user named “Wang” (field 204) uses a host (field 212) at 140.113.28.3 (IP Address; Internet Protocol Address; field 214) to perform a print job (field 210) at 7:21 AM (field 208) Nov. 3, 2006 (field 206), the ID (Identification) of the print job is “151” (field 202), and the actual page count (field 216) sent by “Wang” is eight sheets of monochrome black prints (sub-field 222) and eleven sheets of color prints (sub-field 224), wherein the sub-fields 222 and 224 are listed under an actual page count field 216. The toner coverage K of these eight sheets of monochrome black prints is 36% (sub-field 232), and 36% is divided by 5% with rounding up so as to be converted to the TCA page count, which is about 8. The TCA page count “8” reflects the actual toner cost of monochrome black prints, and can be used as the page count for charging the monochrome black prints. For these eleven sheets of color prints, the toner coverage Y is 23% (sub-field 226); the toner coverage M is 31% (sub-field 228); the toner coverage C is 39% (sub-field 230); and the toner coverage K is 23% (sub-field 232); and (23%+31%+39%+23%) is divided by 20% with rounding up so as to be converted to the TCA page count, which is about 6. However, since the TCA page count calculated “6” is smaller than the actual page count “11, the TCA page count is set to the actual page count “11”. The TCA page count “11” reflects the actual toner cost of color prints, and can be used as the page count for charging the color prints. This example is used to explain that when the TCA page count calculated (the total toner coverage page count) is less than the actual page count, the actual page count is used as the page count for charge, i.e. as the TCA page count.

Such as shown in FIG. 2, when a user named “Tsai” (field 204) uses a host (field 212) at 140.113.28.3 (IP address; field 214) to perform a copy job (field 210) at 10:11 AM (field 208) 2006/11/7 (field 206), the ID of the copy job is “157” (field 202), and the actual page count (field 216) sent by “Tsai” is four sheets of monochrome black copies (sub-field 222) and one sheet of color copy (sub-field 224), wherein the sub-fields 222 and 224 are listed under an actual page count field 216. The toner coverage K of these four sheets of monochrome black copies is 16% (sub-field 232), and 16% is divided by 5% with rounding up so as to be converted to the TCA page count, which is about 4. The TCA page count “4” can be used as the page count for charging the monochrome black prints. For the one sheet of color copy, the toner coverage Y is 5% (sub-field 226); the toner coverage M is 3% (sub-field 228); the toner coverage C is 7% (sub-field 230); and the toner coverage K is 6% (sub-field 232); and (5%+3%+7%+6%) is divided by 20% with rounding up so as to be converted to the TCA page count, which is about 2. Since the actual toner cost reflected by the TCA page count (the total toner coverage page count) is higher than the actual page count, the TCA page count “2” is used as the page count for charge.

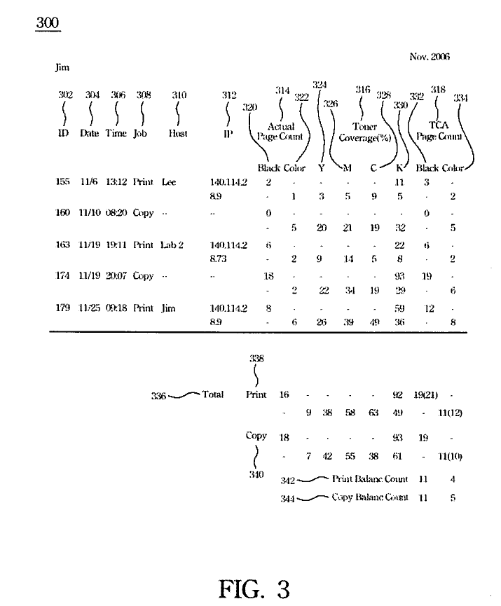

FIG. 3 is a schematic diagram illustrating a personal activity log generated by the method for analyzing the print/copy job according to the embodiment of the present invention. A personal activity log 300 comprises an ID field 302, a date field 304, a time field 306, a job field 308, a host field 310, an IP field 312, an actual page count field 314, a toner coverage field 316 and a TCA page count field 318, generated by compiling a resource-consuming job. Detailedly describing, the actual page count field 314 further includes a black sub-field 320 recording an actual page count of monochrome black job, and a color sub-field 322 recording an actual page count of color black job. The toner coverage field 316 further includes a yellow sub-field 324 recording a yellow toner usage amount, a magenta sub-field 326 recording a magenta toner usage amount, a cyan sub-field 328 recording a cyan toner usage amount, and a black sub-field 330 recording a black toner usage amount. The TCA page count field 318 further includes a black sub-field 332 recording a black TCA page count, and a color sub-field 334 recording a color TCA page count.

Referring to FIG. 3, the report can reflect the activity log of an individual person, wherein the statistical method for the TCA page count is the same as that shown in FIG. 2.

The personal activity log 300 comprises fields 336 and 338 designating a total TCA page count compiled for one person's printing, and fields 336 and 340 designating a total TCA page count compiled for one person's copying. Concretely speaking, the personal activity log 300 compiles the print activities performed by Jim in November 2006, and includes the respective total actual page counts of the monochrome black and color prints; the total black toner coverage of the monochrome black prints; the total yellow toner coverage, total magenta toner coverage, total cyan toner coverage and total black toner coverage of the color prints; and the respective TCA page counts of the monochrome black and color prints. When the total TCA page count for personal activities is compiled, the total TCA of the monochrome black prints can be obtained directly from the sum of 3, 6 and 12, and is equal to 21; or obtained by dividing the total black toner coverage (92%) by 5%, and is equal to about 19. Similarly, the total TCA of the color prints can be obtained directly from the sum of 2, 2 and 8, and is equal to 12; or obtained by dividing the total color toner coverage (38%+58%+63%+49%)) by 20%, and is equal to about 11.

Such as shown in FIG. 3, a print balance page count field 342 and a copy balance page count field 344 are used to record the remaining page counts allowed by personal printing and copying respectively. In other words, an administer may set in a copying/printing apparatus or a network system the page count limits allowed for each person's monochrome black and color print/copy jobs, thereby letting the user or the administer be aware of the user's situation via the report shown in as FIG. 3.

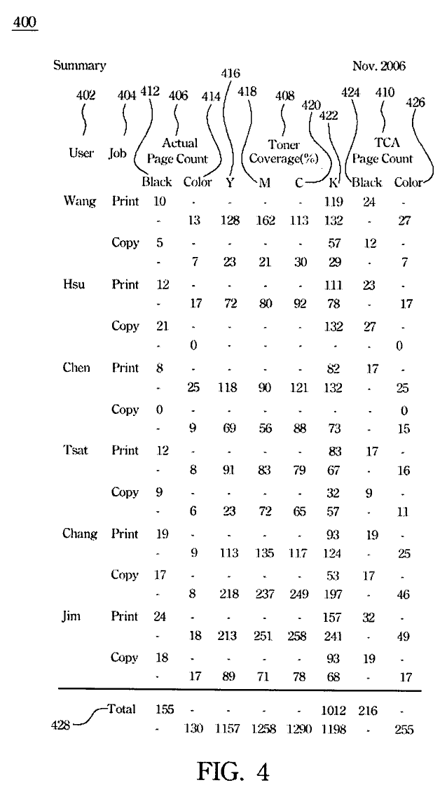

FIG. 4 is a schematic diagram illustrating a summary report generated by the method for analyzing the print/copy job according to the embodiment of the present invention, wherein the summary report is used for compiling and recording the total usage of each user within a predetermined time.

Such as shown in FIG. 4, a summary report 400 of November 2006 is recorded. The summary report 400 records the print or copy job (listed in a job field 404) performed by a user (listed in the user field 402) in November 2006, and includes a color actual page count sub-field 414 recording an actual page count of color print or copy job; a black actual page count sub-field 412 recording an actual page count of monochrome black print or copy job; a toner coverage field 408 further including a yellow sub-field 416 recording a yellow toner usage amount, a magenta sub-field 418 recording a magenta toner usage amount, a cyan sub-field 420 recording a cyan toner usage amount, and a black sub-field 422 recording a black toner usage amount; and the TCA page count field 410 further including a black sub-field 424 recording a back TCA page count, and a color sub-field 426 recording a color TCA page count.

The summary report 400 comprises a total field 428 designating the total print/copy page counts for resource-consuming jobs. Concretely speaking, the summary report 400 records the print/copy activities performed by all the users in November 2006, and includes the total page counts for the monochrome black and color print/copy jobs; the total yellow toner usage amount; the total magenta toner usage amount; the total cyan toner usage amount; the total black toner usage amount; the black TCA page count; and the color TCA page count.

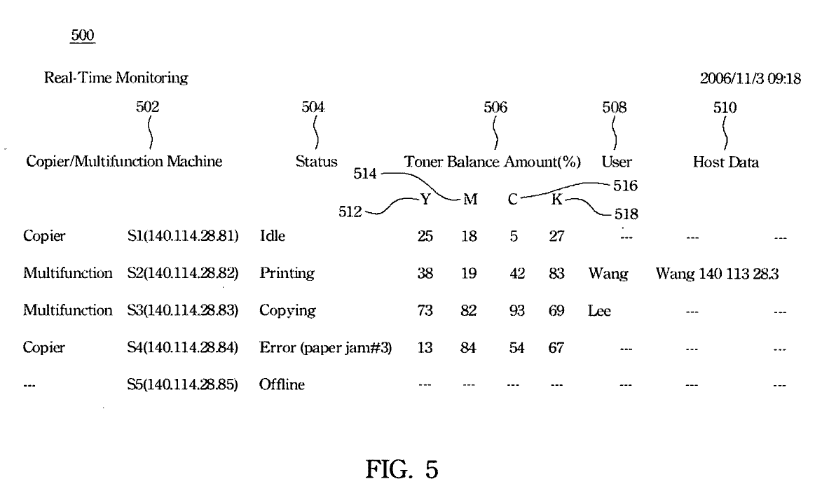

FIG. 5 is a schematic diagram illustrating a real-time monitoring report generated by the method for analyzing the print/copy job according to the embodiment of the present invention. A real-time monitoring report 500 records the activities of several copiers and multifunction machines at 9:18AM 11/30/2006, and includes the status (listed in field 504) of each machine (listed in field 502); a toner balance amount (listed in field 506) thereof; a current user name (listed in field 508) thereof; and a host data (listed in field 510) thereof, wherein at that time point, a copier S1 is idle, and the toner balance amount of the copier S1 includes 25% of yellow toner balance amount; 18% of magenta toner balance amount; 5% of cyan toner balance amount; and 27% of black toner balance amount.

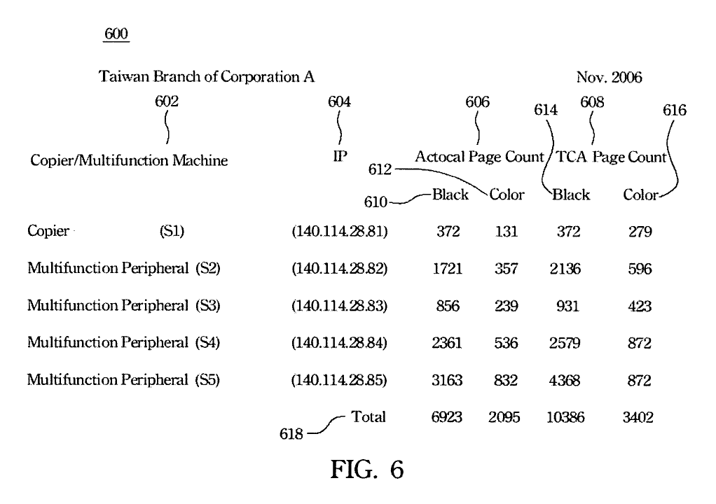

FIG. 6 is a schematic diagram illustrating a summary report of a branch generated by the method for analyzing the print/copy job according to the embodiment of the present invention. The use of this summary report may allow an administer to manage the print/copy jobs at each branch of a corporation. A summary report 600 of a branch includes an actual page count field 606 and a TCA page count field 608 generated by compiling a copier or multifunction machine at the branch. The actual page count field 606 further includes a black sub-field 610 recording an actual page count for a monochrome black print/copy job; and a color sub-field 612 recording an actual page count for a color print/copy job. The TCA page count field 608 further includes a black sub-field 614 recording a TCA page count for a monochrome black print/copy job; and a color sub-field 616 recording a TCA page count for a color print/copy job.

Such as shown in FIG. 6, the summary report 600 of the branch records the activities performed by the copiers and multifunction machines located at Taiwan branch of corporation A in November 2006, for example, recording the total actual page count and the total TCA page count of a copier S1 (having an IP address 140.114.28.81). The summary report 600 of the branch includes compiling a total print/copy amount (field 618) for the branch, such as a total TCA page account of color print/copy jobs recorded in a field designated by the color sub-field 616 and the field 618.

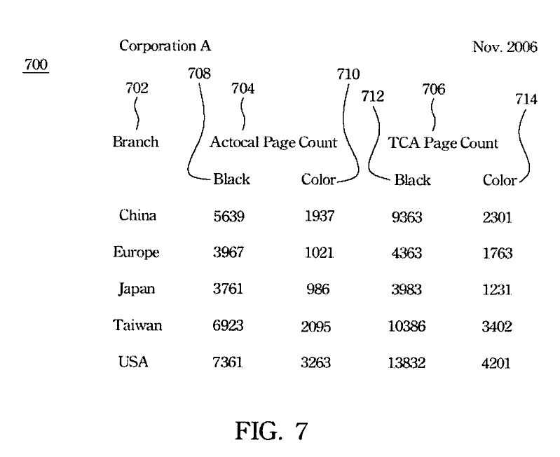

FIG. 7 is a schematic diagram illustrating a summary report of a corporation generated by the method for analyzing the print/copy job according to the embodiment of the present invention. A summary report 700 of a corporation includes an actual page count field 704 recording an actual page count; and a TCA page count field 706 recording an TCA page count, by compiling the print/copy activities at each branch (list in a field 702). The actual page count field 704 further includes a black sub-field 708 recording an actual page count for monochrome black print/copy jobs; and a color sub-field 710 recording an actual page count for color print/copy jobs. The TCA page count field 706 further includes a black sub-field 712 recording a TCA page count for monochrome black print/copy jobs; and a color sub-field 714 recording a TCA page count for a color print/copy job. The use of this report may allow an administer to analyze the print/copy job activities at all of the branches of the corporation, and a reasonable cost estimation of the print/copy jobs can be obtained accordingly.

It can be known from the embodiment of the present invention that: the cephalogram image analysis method of the present invention can effectively and accurately convert a cephalogram into a tracing diagram, thus saving time and effort, and avoiding relying on expert experience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for analyzing at least one print/copy job, comprising:
recording an actual page count of each of the at least one print/copy job;
compiling a total toner coverage for each of the at least one print/copy job;
obtaining a total toner coverage page count via a computation using a predetermined threshold value and the total toner coverage, wherein the predetermined threshold value is an amount of a toner coverage for a print/copy page under normal fare, and when the actual page count of the print/copy job is less than the total toner coverage page count, a toner coverage adjustment (TCA) page count is equal to the total toner coverage page count; and
producing a report in accordance with the at least one print/copy job.

2. The method as claimed in claim 1, wherein the total toner coverage page count is equal to the total toner coverage divided by the predetermined threshold value, and the toner coverage adjustment page count is obtained by rounding up.

3. The method as claimed in claim 1, wherein the total toner coverage is the sum of all color toner coverages when the print/copy job is a color print job or a color copy job.

4. The method as claimed in claim 1, wherein the total toner coverage is a black toner coverage when the print/copy job is a monochrome black print job or a monochrome black copy job.

5. The method as claimed in claim 1, wherein the predetermined threshold value is substantially 20% when the print/copy job is a color print job or a color copy job.

6. The method as claimed in claim 1, wherein the predetermined threshold value is substantially 5% when the print/copy job is a monochrome black print job or a monochrome black copy job.

7. The method as claimed in claim 1, wherein the report is an activity log, and the activity log comprises a toner coverage adjustment page count field recording the toner coverage adjustment page count generated by compiling the print/copy job.

8. The method as claimed in claim 7, wherein the toner coverage adjustment page count field further comprises a black sub-field recording a black toner coverage adjustment page count, and a color sub-field recording a color toner coverages adjustment page count.

9. The method as claimed in claim 1, wherein the report is a personal activity log, and the personal activity log comprises an actual page count field, a toner coverage field and a toner coverage adjustment page count field, for compiling the print/copy job.

10. The method as claimed in claim 9, wherein the actual page count field comprises a first black sub-field recording an actual monochrome black page count, and a first color sub-field recording an actual color page count; and
the toner coverage field comprises a yellow sub-field recording a yellow toner usage amount, a magenta sub-field recording a magenta toner usage amount, a cyan sub-field recording a cyan toner usage amount, and a second black sub-field recording a black toner usage amount; and
the toner coverage adjustment page count field comprises a third black sub-field recording a black toner coverage adjustment page count, and a second color sub-field recording a color toner coverage adjustment page count.

11. The method as claimed in claim 9, wherein the personal activity log comprises an identification (ID) field, a date field, a time field, a job field, a host field and an internet protocol (IP) field, for the print/copy job.

12. The method as claimed in claim 1, wherein the report is a personal activity log, and the personal activity log comprises a total toner coverage adjustment page count compiled for one person's printing or copying.

13. The method as claimed in claim 1, wherein the report is a personal activity log, and the personal activity log comprises a print balance count or a copy balance count compiled for one person.

14. The method as claimed in claim 1, wherein the report is a summary report, and the summary report comprises a user field and a toner coverage adjust page count field summarily recording the toner coverage adjust page count used by a user recorded in the user field.

15. The method as claimed in claim 1, wherein the report is a summary report, and the summary report comprises a total toner coverage adjustment page count compiled for the at least one print/copy job within a predetermined time.

16. The method as claimed in claim 1, wherein the report is a real-time monitoring report, and the real-time monitoring report comprises a status field recording a current copying/printing apparatus, a toner balance field recording at least one toner balance amount, and a user field recording a user.

17. The method as claimed in claim 16, wherein the toner balance field comprises a plurality of sub-fields recording each color toner's balance amount.

18. The method as claimed in claim 1, wherein the report is a summary report of a branch, and the summary report of the branch comprises an actual page count field recording the actual page count generated by a copying/printing apparatus at the branch, and a toner coverage adjust page count field recording the tone coverage adjust page count.

19. The method as claimed in claim 18, wherein the actual page count field comprises a first black sub-field recording an actual monochrome black page count, and a first color sub-field recording an actual color page count; and
the toner coverage adjustment page count field comprises a second black sub-field recording a black toner coverage adjustment page count, and a second color sub-field recording a color toner coverage adjustment page count.

20. The method as claimed in claim 1, wherein the report is a summary report of a branch, and the summary report of the branch comprises a total toner coverage adjustment page count at the branch.

21. The method as claimed in claim 1, wherein the report is a summary report of a corporation having at least one branch, and the summary report of the corporation comprises an actual page count field recording the actual page count generated by the at least one branch, and a toner coverage adjust page count field recording the tone coverage adjust page count.

22. A method for analyzing a print/copy job, comprising:
recording an actual page count the print/copy job;
compiling a total toner coverage for the print/copy job;
dividing the total toner coverage by a predetermined threshold value to obtain a total toner coverage page count, wherein the predetermined threshold value is an amount of a toner coverage for a print/copy page under normal fare; and
generating a toner coverage adjustment page count, and using the toner coverage adjustment page count as a fare computation count for the print/copy job, wherein when the total toner coverage page count is greater than the actual page count, the toner coverage adjustment page count is equal to the total toner coverage page count.
